(19) United States
(12) Patent Application Publication
(10) Pub. No.: US 2026/0194779 A1
(43) Pub. Date: Jul. 9, 2026

(54) DIMMING DEVICE, MANUFACTURING METHOD THEREOF AND VEHICLE

(71) Applicants: Beijing BOE Sensor Technology Co., Ltd., Beijing (CN); BOE TECHNOLOGY GROUP CO., LTD., Beijing (CN)

(72) Inventors: Juan CHEN, Beijing (CN); Chunlei WANG, Beijing (CN); Changyin WANG, Beijing (CN); Peng LIANG, Beijing (CN); Xiaolong WU, Beijing (CN); Chuang YONG, Beijing (CN)

(21) Appl. No.: 18/727,647

(22) PCT Filed: Dec. 27, 2022
(86) PCT No.: PCT/CN2022/142274

§ 371 Date: Jul. 9, 2024

(51) Int. Cl. G02F 1/1339; B60J 3/04

(52) U.S. Cl. CPC G02F 1/13394; B60J 3/04; G02F 1/1339

(57) ABSTRACT

A dimming device includes a first substrate (1), a first adhesive layer (3), a dimming assembly (5), a second adhesive layer (4) and a second substrate (2) sequentially stacked together. The dimming assembly includes a third substrate (51), a first sealant (52), a plurality of spacers (53), and a fourth substrate (54), the third substrate and the fourth substrate are aligned and assembled to form an alignment gap therebetween, and liquid crystal (50) is filled in the alignment gap. The spacers are positioned between the third substrate and the fourth substrate, and surrounded by the first sealant. The first sealant is positioned between the third substrate and the fourth substrate. The first adhesive layer and the second adhesive layer at least cover an effective dimming region of the dimming assembly. Each of the first and second adhesive layers may adopt a solid or liquid adhesive.

### CROSS-REFERENCE TO RELATED APPLICATIONS

This is a National Phase Application filed under 35 U.S.C. 371 as a national stage of PCT/CN2022/142274 filed on Dec. 27, 2022, the entire content of which is incorporated herein by reference.

### TECHNICAL FIELD

Embodiments of the present disclosure relates to the field of display technology, and in particular, relates to a dimming device (i.e., a light adjustment device, a light adjustor, a light modulation device, or a light modulator), a manufacturing method thereof, and a vehicle.

### BACKGROUND

A flexible dye liquid crystal dimmer (i.e., a flexible dye liquid crystal light adjustor or a flexible dye liquid crystal light modulator) has advantages such as lightness and thinness, flexibility, privacy protection, and the like, and thus meets the hyperbolic and lightweight requirements of a sunroof and a side window of a passenger vehicle. Further, the flexible dye liquid crystal dimmer can provide simple grey black and thus shows a high grade, which brings more intelligent, comfortable driving experiences for a user.

### SUMMARY

In a first aspect, embodiments of the present disclosure provide a dimming device, which includes a first substrate, a second substrate, a first adhesive layer, a second adhesive layer, and a dimming assembly; wherein
the first substrate, the first adhesive layer, the dimming assembly, the second adhesive layer and the second substrate are sequentially stacked together;
the dimming assembly includes a third substrate, a first sealant, a plurality of spacers, and a fourth substrate, the third substrate and the fourth substrate are aligned and assembled to form an alignment gap therebetween, and liquid crystal is filled in the alignment gap;
the plurality of spacers are positioned between the third substrate and the fourth substrate, and positioned in a region surrounded by the first sealant;
the first sealant is positioned between the third substrate and the fourth substrate, and surrounds peripheral regions of the third substrate and the fourth substrate, so as to bond and encapsulate the peripheral regions of the third substrate and the fourth substrate;
the first adhesive layer and the second adhesive layer at least cover an effective dimming region of the dimming assembly;
the effective dimming region is a region surrounded by the first sealant; and
each of the first adhesive layer and the second adhesive layer is a solid adhesive; or, at least one of the first adhesive layer and the second adhesive layer is made of a liquid adhesive.

In some embodiments, orthogonal projections of a first side of the dimming assembly, the first adhesive layer, and the second adhesive layer on a plane where the first substrate is located do not overlap with each other; and
the first sealant extends at the first side to form at least one opening, an end of each opening is flush with first sides of the third substrate and the fourth substrate, and is sealed by an opening-sealing adhesive, and the at least one opening is configured to fill the liquid crystal into the alignment gap.

In some embodiments, the first adhesive layer and the second adhesive layer extend to and encapsulate end faces of other sides of the dimming assembly except the first side.

In some embodiments, orthogonal projections of the first substrate, the second substrate, the first adhesive layer and the second adhesive layer on the plane where the first substrate is located coincide with each other.

In some embodiments, the first sealant surrounds to form a closed ring shape;
the first adhesive layer and the second adhesive layer extend to and encapsulate an end face of a periphery of the dimming assembly; and
a periphery of an orthogonal projection of each of the first adhesive layer and the second adhesive layer on the first substrate surrounds outside a periphery of an orthogonal projection of the first sealant on the first substrate.

In some embodiments, orthogonal projections of the first substrate and the second substrate on a plane where the first substrate is located coincide with each other;
orthogonal projections of the first adhesive layer and the second adhesive layer on the plane where the first substrate is located coincide with each other; and
a periphery of each of the orthogonal projections of the first substrate and the second substrate on a plane where the first substrate is located surrounds outside a periphery of each of the orthogonal projections of the first adhesive layer and the second adhesive layer on the plane where the first substrate is located.

In some embodiments, the dimming device further includes a second sealant, which is disposed between the first substrate and the second substrate, surrounds the peripheral regions of the first substrate and the second substrate, and is in contact with and connected to the first substrate and the second substrate; and
an orthogonal projection of the second sealant on the first substrate is positioned outside the orthogonal projections of the first adhesive layer and the second adhesive layer on the first substrate.

In some embodiments, orthogonal projections of other sides of the first substrate, the dimming assembly, and the second substrate except the first side on the plane where the first substrate is located overlap with each other;
orthogonal projections of the other sides of the dimming assembly except the first side, the first adhesive layer, and the second adhesive layer on the plane where the first substrate is located do not overlap with each other;
orthogonal projections of the first substrate and the second substrate on the plane where the first substrate is located coincide with each other;
the orthogonal projections of the first adhesive layer and the second adhesive layer on the plane where the first substrate is located coincide with each other; and
a periphery of each of the orthogonal projections of the first substrate and the second substrate on the plane where the first substrate is located surrounds outside a periphery of each of the orthogonal projections of the first adhesive layer and the second adhesive layer on the plane where the first substrate is located.

In some embodiments, the first sealant surrounds to form a closed ring shape;
orthogonal projections of peripheries of the first substrate, the dimming assembly, and the second substrate on a plane where the first substrate is located overlap with each other;
orthogonal projections of a periphery of the dimming assembly, the first adhesive layer, and the second adhesive layer on the plane where the first substrate is located do not overlap with each other;
orthogonal projections of the first substrate and the second substrate on the plane where the first substrate is located coincide with each other;
orthogonal projections of the first adhesive layer and the second adhesive layer on the plane where the first substrate is located coincide with each other; and
a periphery of each of the orthogonal projections of the first substrate and the second substrate on the plane where the first substrate is located surrounds outside a periphery of each of the orthogonal projections of the first adhesive layer and the second adhesive layer on the plane where the first substrate is located.

In some embodiments, the dimming device further includes a second sealant, which is disposed between the first substrate and the dimming assembly, surrounds peripheral regions of the first substrate and the dimming assembly, and is in contact with and connected to the first substrate and the dimming assembly;
the second sealant is further positioned between the second substrate and the dimming assembly, surrounds the peripheral regions of the second substrate and the dimming assembly, and is in contact with and connected to the second substrate and the dimming assembly; and
an orthogonal projection of the second sealant on the first substrate is positioned outside each of orthogonal projections of the first adhesive layer and the second adhesive layer on the first substrate.

In some embodiments, the first adhesive layer and the second adhesive layer are both the solid adhesives; or, one of the first adhesive layer and the second adhesive layer is made of the liquid adhesive; and
each solid adhesive includes polyvinyl butyral or ethylene-vinyl acetate copolymer.

In some embodiments, each of the first adhesive layer and the second adhesive layer is made of the liquid adhesive which achieves adhesion after being cured; and
the liquid adhesive includes an acrylic resin optical adhesive or an organic silicon optical adhesive.

In some embodiments, the second sealant has a width in a range of 2 mm to 6 mm.

In some embodiments, the dimming device further includes an edge-sealing adhesive, which is located on the first side of the dimming assembly, and on a side of the opening-sealing adhesive distal to the at least one opening; and
the edge-sealing adhesive extends to cover the first side.

In some embodiments, the edge-sealing adhesive has a width in a range of 1 cm to 2 cm.

In some embodiments, the third substrate includes a first flexible substrate, a first electrode layer, and a first alignment film;
the first electrode layer and the first alignment film are sequentially stacked on the first flexible substrate;
the fourth substrate includes a second flexible substrate, a second electrode layer, and a second alignment film;
the second electrode layer and the second alignment film are sequentially stacked on the second flexible substrate;
the plurality of spacers are uniformly distributed on the first electrode layer; and
a top end of at least a part of the spacers is in contact with the second alignment film.

In some embodiments, the first electrode layer further extends beyond the first sealant and forms a first binding electrode;
the second electrode layer further extends beyond the first sealant and forms a second binding electrode;
the first binding electrode and the second binding electrode are positioned on a same side of the dimming assembly, and orthogonal projections of the first binding electrode and the second binding electrode on the first flexible substrate do not overlap with each other;
the dimming device further includes a first flexible circuit board and a second flexible circuit board;
the first binding electrode is bound and connected to the first flexible circuit board; and
the second binding electrode is bound and connected to the second flexible circuit board.

In some embodiments, a shape of each of the spacers includes any one of a cylinder, a frustum of a cone, or a frustum of a pyramid.

In some embodiments, each spacer having the shape of a frustum of a cone has a bottom surface of which a diameter is in a range of 25 μm to 30 μm, a top surface of which a diameter is in a range of 15 μm to 20μm, and a height in a range of 8 μm to 12 μm.

In some embodiments, a distance between any adjacent two of the spacers is in a range of 70 μm to 170 μm; and
a distance between the spacer closest to the first sealant and the first sealant is in a range of 100 μm to 1,000 μm.

In a second aspect, the embodiments of the present disclosure further provide a vehicle, which includes the dimming device according to any one of the foregoing embodiments, and the dimming device serves as a window of the vehicle.

In a third aspect, embodiments of the present disclosure further provide a method for manufacturing a dimming device, the method including: forming a dimming assembly of which an alignment gap is not filled with liquid crystal;
sequentially stacking a first substrate, a first adhesive layer, the dimming assembly of which an alignment gap is not filled with liquid crystal, a second adhesive layer, and a second substrate and assembling them together in a high-pressure kettle, in a case where each of the first adhesive layer and the second adhesive layer is a solid adhesive;
filling liquid crystal into the alignment gap through an opening for filling liquid crystal in a vacuum chamber at a normal temperature;
sealing the opening for filling liquid crystal by using an opening-sealing adhesive;
in a case where the first adhesive layer is the solid adhesive and the second adhesive layer is made of a liquid adhesive, sequentially stacking the first substrate, the first adhesive layer, and the dimming assembly of which an alignment gap is not filled with liquid crystal, and assembling them together in the high-pressure kettle;
filling liquid crystal into the alignment gap through an opening for filling liquid crystal in a vacuum chamber at a normal temperature;
sealing the opening for filling liquid crystal by using an opening-sealing adhesive, to form a semi-finished product;
attaching the semi-finished product to the second substrate to form a cavity and reserve an injection opening in an adhesive for the attaching, injecting a material of the second adhesive layer into the cavity, and curing the material of the second adhesive layer;
in a case where each of the first adhesive layer and the second adhesive layer is made of the liquid adhesive, attaching the first substrate to the dimming assembly of which an alignment gap is not filled with liquid crystal to form a cavity and reserve an injection opening in an adhesive for the attaching, injecting a material of the first adhesive layer into the cavity, and curing the material of the first adhesive layer, to form a semi-finished product;
attaching the semi-finished product to the second substrate to form a cavity and reserve an injection opening in an adhesive for the attaching, injecting a material of the second adhesive layer into the cavity, and curing the material of the second adhesive layer;
filling liquid crystal into the alignment gap through an opening for filling liquid crystal in a vacuum chamber at a normal temperature; and
sealing the opening for filling liquid crystal by using an opening-sealing adhesive.

In a fourth aspect, embodiments of the present disclosure further provide a method for manufacturing a dimming device, the method including: forming a dimming assembly of which an alignment gap is filled with liquid crystal; and forming a plurality of spacers in the dimming assembly by using a patterning process or a screen printing process;
sequentially stacking a first substrate, a first adhesive layer, the dimming assembly, a second adhesive layer, and a second substrate and assembling them together in a high-pressure kettle, in a case where each of the first adhesive layer and the second adhesive layer is a solid adhesive;
in a case where the first adhesive layer is the solid adhesive and the second adhesive layer is made of a liquid adhesive, sequentially stacking the first substrate, the first adhesive layer, and the dimming assembly, and assembling them together in the high-pressure kettle, to form a semi-finished product;
attaching the semi-finished product to the second substrate to form a cavity and reserve an injection opening in an adhesive for the attaching, injecting a material of the second adhesive layer into the cavity, and curing the material of the second adhesive layer;
in a case where each of the first adhesive layer and the second adhesive layer is made of the liquid adhesive, attaching the first substrate to the dimming assembly to form a cavity and reserve an injection opening in an adhesive for the attaching, injecting a material of the first adhesive layer into the cavity, and curing the material of the first adhesive layer, to form a semi-finished product; and
attaching the semi-finished product to the second substrate to form a cavity and reserve an injection opening in an adhesive for the attaching, injecting a material of the second adhesive layer into the cavity, and curing the material of the second adhesive layer.

In some embodiments, the solid adhesive, which realizes adhesion after being melted, is in a molten state at a temperature of 120° C. to 150° C. and under a pressure of 12 bar to 14 bar, and is solidified after cooling; and
the liquid adhesive, which realizes adhesion after being solidified, is solidified after being subjected to keeping at a temperature of 60° C. to 80° C. for 15 min to 30 min, statically leveling for 10 min, and defoaming at 40° C. to 60° C. for 30 min to 50 min.

### BRIEF DESCRIPTION OF THE DRAWINGS

The accompanying drawings, which are included to provide a further understanding of exemplary embodiments of the present disclosure and constitute a part of this specification, illustrate the present disclosure together with the exemplary embodiments, and are not intended to limit the present disclosure. The above and other features and advantages will become more apparent to one of ordinary in the art by describing in detail the exemplary embodiments thereof with reference to the accompanying drawings, in which:

FIG. 1a is a schematic top view illustrating a structure of a dimming device according to an embodiment of the present disclosure;

FIG. 1b is a schematic cross-sectional view illustrating a structure of the dimming device shown in FIG. 1a taken along a section line AA;

FIG. 1c is a partially enlarged view of openings for filling liquid crystal of a dimming assembly shown in FIG. 1a;

FIG. 1d is a schematic top view illustrating a structure of another dimming device according to an embodiment of the present disclosure;

FIG. 2 is a schematic view illustrating the overlapping (or lamination) of layers in a dimming device according to an embodiment of the present disclosure;

FIG. 3 is a schematic cross-sectional view illustrating a structure of a dimming assembly according to an embodiment of the present disclosure;

FIG. 4 is a schematic view illustrating a structure of a spacer according to an embodiment of the present disclosure;

FIG. 5a is a schematic top view illustrating a structure of another dimming device according to an embodiment of the present disclosure;

FIG. 5b is a schematic cross-sectional view illustrating a structure of the dimming device shown in FIG. 5a taken along a section line BB;

FIG. 6a is a schematic top view illustrating a structure of another dimming device according to an embodiment of the present disclosure;

FIG. 6b is a schematic cross-sectional view illustrating a structure of the dimming device shown in FIG. 6a taken along a section line CC;

FIG. 7a is a schematic top view illustrating a structure of another dimming device according to an embodiment of the present disclosure;

FIG. 7b is a schematic cross-sectional view illustrating a structure of the dimming device shown in FIG. 7a taken along a section line DD;

FIG. 8a is a schematic top view illustrating a structure of another dimming device according to an embodiment of the present disclosure;

FIG. 8b is a schematic cross-sectional view illustrating a structure of the dimming device shown in FIG. 8a taken along a section line EE;

FIG. 9a is a schematic top view illustrating a structure of another dimming device according to an embodiment of the present disclosure;

FIG. 9b is a schematic cross-sectional view illustrating a structure of the dimming device shown in FIG. 9a taken along a section line FF;

FIG. 10 is a schematic top view illustrating a structure of another dimming device according to an embodiment of the present disclosure; and

FIG. 11 is a schematic top view illustrating a structure of another dimming device according to an embodiment of the present disclosure.

### DETAILED DESCRIPTION OF EMBODIMENTS

To help one of ordinary in the art better understand technical solutions of the embodiments of the present disclosure, a dimming device, a manufacturing method thereof, and a vehicle provided by the embodiments of the present disclosure will be described below in further detail with reference to the accompanying drawings and the following description.

The embodiments of the present disclosure will be described more fully hereinafter with reference to the accompanying drawings, but the embodiments shown may be embodied in different forms and should not be construed as limited to the embodiments set forth herein. Rather, these embodiments are provided such that the present disclosure will be thorough and complete, and will fully convey the scope of the present disclosure to one of ordinary in the art.

Embodiments of the present disclosure are not limited to the embodiments shown in the drawings, but include modifications of configurations formed based on a manufacturing process. Thus, the regions illustrated in the figures have schematic properties, and the shapes of the regions shown in the figures illustrate exemplary shapes of the regions, but are not intended to be limiting.

In the related technology, windows of a passenger vehicle should be hyperbolic, light and thin, for energy saving, safety, and being not easy to break.

Rigid dye liquid crystal dimming glasses are formed by stacking two pieces of toughened glass and a rigid dimming functional layer together. The rigid dimming functional layer is formed by aligning and assembling two glass substrates into a cell, and filling dye liquid crystal in the cell. Although the rigid dye liquid crystal dimming glasses have the advantages that the color, the response time and the haze degree thereof meet the traffic application requirements, the glass substrates of the rigid dimming functional layer are fragile, and thus are difficult to meet the fragment standard of a passenger vehicle and is difficult to obtain a better application in the field of passenger vehicles in consideration of personal safety. Further, the rigid dye liquid crystal dimming glasses also have great difficulties in hyperbolic spheroidization.

Flexible dye liquid crystal dimming glasses are formed by stacking two pieces of toughened glass and a flexible dimming functional layer together. The flexible dimming functional layer is formed by aligning and assembling two flexible substrates into a cell, and filling dye liquid crystal in the cell. The flexible dye liquid crystal dimming glasses are subjected to a process of clipping the two pieces of glass from both sides by using solid adhesive (such as PVB (polyvinyl butyral) and EVA (ethylene-vinyl acetate copolymer)) at a high temperature and a high pressure, and in this process serious Mura phenomenon occurs because the liquid crystal being subjected to uneven pressure or a height (or thickness) of an adhesive layer fluctuating above a micrometer level causes the Mura phenomenon to occur in the flexible dimming functional layer.

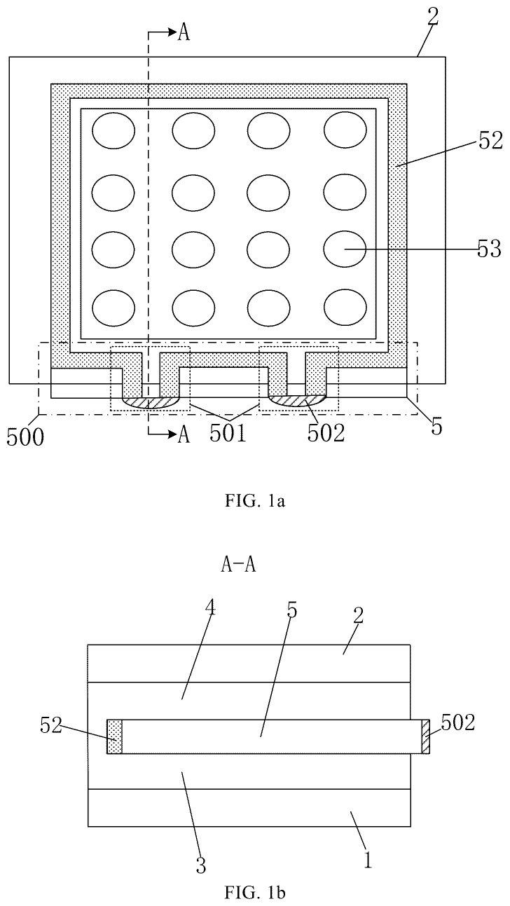

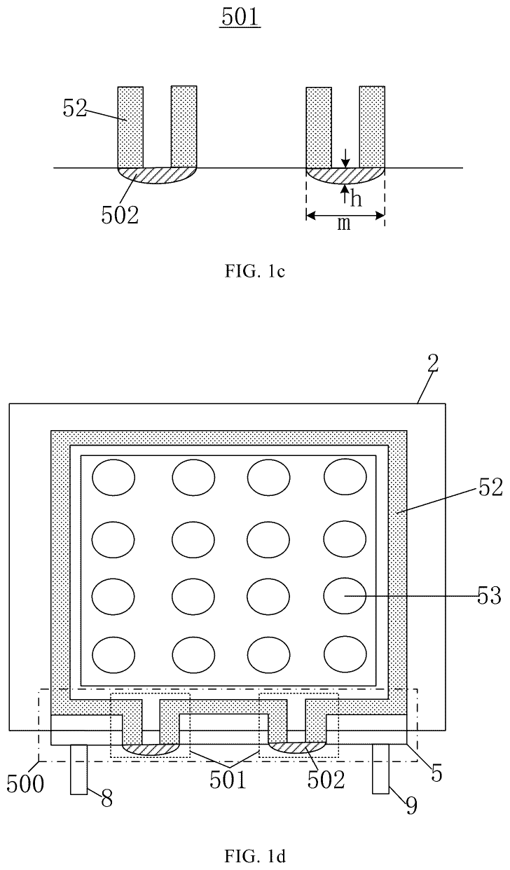

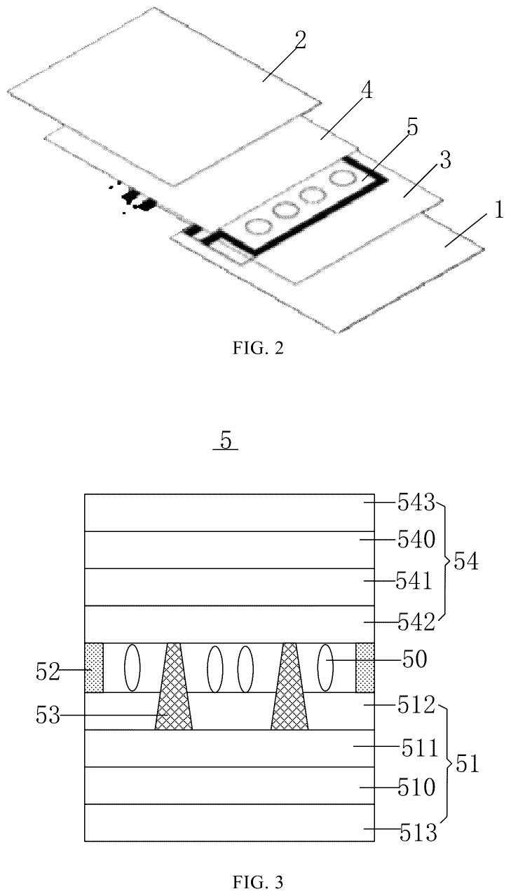

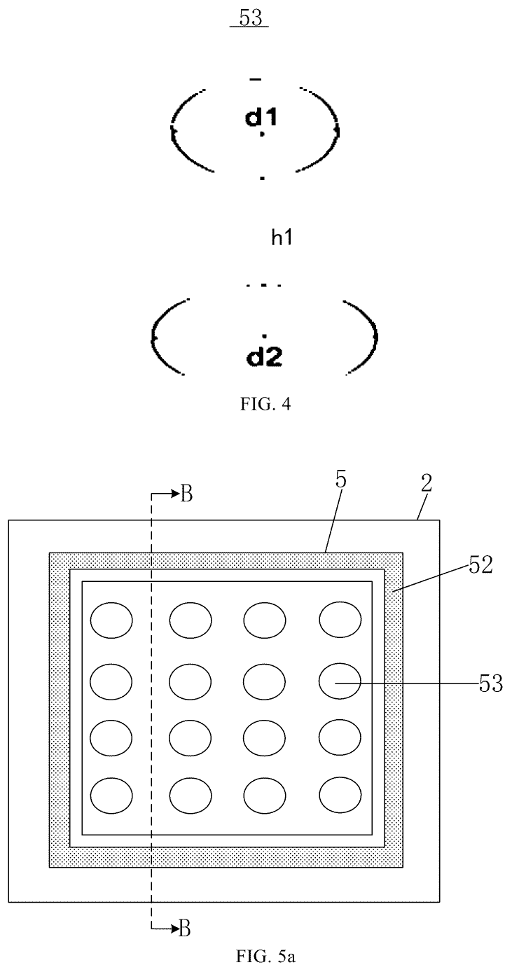

In order to solve the above problems in the related art, in a first aspect, an embodiment of the present disclosure provides a dimming device. FIG. 1a is a schematic top view illustrating a structure of a dimming device according to the present embodiment, and FIG. 1b is a schematic cross-sectional view illustrating a structure of the dimming device shown in FIG. 1a taken along a section line AA. FIG. 2 is a schematic view illustrating the overlapping (or lamination) of layers in the dimming device according to the present embodiment, and FIG. 3 is a schematic cross-sectional view illustrating a structure of a dimming assembly according to the present embodiment. The dimming device includes a first substrate 1, a second substrate 2, a first adhesive layer 3, a second adhesive layer 4, and a dimming assembly 5. The first substrate 1, the first adhesive layer 3, the dimming assembly 5, the second adhesive layer 4 and the second substrate 2 are sequentially stacked together. The dimming assembly 5 includes a third substrate 51, a first sealant 52, a plurality of spacers 53, and a fourth substrate 54. The third substrate 51 and the fourth substrate 54 are aligned and assembled to form a cell and have an alignment gap, and the alignment gap is filled with a liquid crystal 50. The plurality of spacers 53 are located between the third substrate 51 and the fourth substrate 54, and located in a region surrounded by the first sealant 52. The first sealant 52 is disposed between the third substrate 51 and the fourth substrate 54, and surrounds the peripheral regions of the third substrate 51 and the fourth substrate 54 to bond and encapsulate the peripheral regions of the third substrate 51 and the fourth substrate 54. The first adhesive layer 3 and the second adhesive layer 4 at least cover an effective dimming region of the dimming assembly 5, and the effective dimming region is a region surrounded by the first sealant 52. The first adhesive layer 3 and the second adhesive layer 4 are both solid adhesive. Alternatively, at least one of the first adhesive layer 3 and the second adhesive layer 4 is made of a liquid adhesive.

In some embodiments, each solid adhesive includes polyvinyl butyral (PVB) or ethylene-vinyl acetate copolymer (EVA). The liquid adhesive includes acrylic resin optical adhesive or organic silicon optical adhesive, such as vinyl polysiloxane-hydrogen containing polysiloxane (OCR).

In some embodiments, each solid adhesive may be, for example, PVB (polyvinyl butyral) or EVA (ethylene-vinyl acetate copolymer), and the liquid adhesive may be, for example, OCR (vinyl polysiloxane-hydrogen containing polysiloxane, e.g., one of type US108). The solid adhesive is an adhesive which can realize bonding after being melted, and the liquid adhesive is an adhesive which can realize bonding after being solidified. The PVB has a thickness ranging from 0.38 mm to 0.76 mm, a flow starting temperature >90° C., a bonding temperature>120° C., Tr % (transmittance)≥85%, Hz % (haze degree)>0.6%, ΔYI (yellowing index or yellowing rate or yellowing indicator)≤10, and a UV light cut-off rate at 400 nm≥99%, and the PVB can filter out UV light below 400 nm, such that a dye in the dye liquid crystal is protected from being damaged, and the condition that the blackness of the dye is insufficient is avoided. The EVA has a thickness ranging from 0.38 mm to 0.76 mm, a flow starting temperature>80° C., a bonding temperature>100° C., Tr % (transmittance)>85%, Hz % (haze degree)>0.6%, and a UV light cut-off rate at 380 nm≥98%, and the EVA can filter out UV light below 400 nm, such that a dye in the dye liquid crystal is protected from being damaged, and the condition that the blackness of the dye is insufficient is avoided. The OCR has a thickness ranging from 0.2 mm to 5 mm, a curing condition at 60° C. to 80° C. for 15 min to 30 min, Tr % (transmittance)>99%, Hz % (haze degree)<0.2, ΔYI (yellowing index or yellowing rate or yellowing indicator)<0.2, Tg (a temperature for converting the OCR from a glass state to a viscous state) of −38.9° C., a shrinkage rate<0.1%, and the OCR becomes a colorless transparent solid after being cured and thus has no UV light cut-off function.

In some embodiments, each of the first adhesive layer 3 and the second adhesive layer 4 is the solid adhesive, and in this case, after the first substrate 1, the first adhesive layer 3, the dimming assembly 5 in which liquid crystal is not filled, the second adhesive layer 4 and the second substrate 2 are stacked together, the liquid crystal 50 may be filled into the dimming assembly 5, thereby avoiding the Mura phenomenon caused by the uneven pressure applied to the liquid crystal 50 during stacking.

In some embodiments, one of the first adhesive layer 3 and the second adhesive layer 4 is made of the liquid adhesive, and in this case, the liquid adhesive may be filled to be cured and bond to the other of the first adhesive layer 3 and the second adhesive layer 4 after layers above and below the one of the first adhesive layer 3 and the second adhesive layer 4 are stacked together. Alternatively, each of the first adhesive layer 3 and second adhesive layer 4 is made of the liquid adhesive, and in this case, the liquid adhesive may be filled to realize solidification and a bonding effect of the first adhesive layer 3 and the second adhesive layer 4 after the first substrate 1, the dimming assembly 5 and the second substrate 2 are aligned and assembled. Thus, in these cases, the Mura phenomenon caused by unevenness of the thickness of the adhesive layer fluctuating beyond a micrometer level is avoided.

In some embodiments, each of the first adhesive layer 3 and the second adhesive layer 4 has a thickness in the range of 0.38 mm to 0.76 mm.

In some embodiments, referring to FIG. 4 that is schematic view illustrating a structure of each spacer according to the present embodiment, the spacer 53 is a columnar spacer 53, and the columnar spacer 53 is formed by a patterning process or a screen printing process. In some embodiments, the spacer 53 is made of a flexible material. The spacer 53 has an elastic recovery rate of 80% to 90% under a pressure of 5 mN to 30 mN.

In some embodiments, the plurality of spacers 53 are evenly spaced apart from each other to have a same interval (i.e., an identical interval) therebetween. A distance between any adjacent two of the spacers 53 ranges from 70 μm to 170 μm. A distance between the spacer 53 closest to the first sealant 52 and the first sealant 52 ranges from 100 μm to 1,000 μm.

In the present embodiment, compared with a spherical spacer sprayed on a substrate on one side in the prior art in a spraying manner, on one hand, the columnar spacers 53 formed by the patterning process or the screen printing process have good distribution uniformity, and on the other hand, the spacers 53 are in surface contact with each substrate, such that the contact adhesion between the spacers 53 and each substrate is firmer, good support in a process of stacking layers of the dimming device together can be satisfied, and the Mura phenomenon in the process of stacking layers of the dimming device together is avoided.

In some embodiments, each of the spacers 53 is made of a material of photoresist, hard resin, or glass. In some embodiments, an opaque material such as ink may be added to a light-transmitting material (or a transparent material) of each spacer 53, so as to reduce a light transmittance of each spacer 53, thereby reducing a transmittance of a dark state of the dimming device, improving a contrast of the dimming device, and improving the visual experience of a user.

In some embodiments, a shape of each spacer 53 includes any one of a cylinder, a frustum of a cone, and a frustum of a pyramid. In some embodiments, a diameter d2 of a bottom surface of a spacer 53, which has a shape of a frustum of a cone, ranges from 25 μm to 30 μm, a diameter d1 of a top surface of the spacer 53 ranges from 15 μm to 20 μm, and a height h1 of the spacer 53 ranges from 4 μm to 30 μm. In some embodiments, the diameter of the bottom surface of the spacer 53 is 27 μm, the diameter of the top surface of the spacer 53 is 19 μm, and the height of the spacer 53 ranges from 8 μm to 12 μm.

In some embodiments, the third substrate 51 includes a first flexible substrate 510, and a first electrode layer 511 and a first alignment film 512 which are sequentially disposed on the first flexible substrate 510. The fourth substrate 54 includes a second flexible substrate 540, and a second electrode layer 541 and a second alignment film 542 which are sequentially disposed on the second flexible substrate 540. The first sealant 52 is located between the first alignment film 512 and the second alignment film 542, and located in a peripheral region of the first alignment film 512 and the second alignment film 542. The plurality of columnar spacers 53 are uniformly distributed on the first electrode layer 511, and top ends of at least a portion of the spacers 53 are in contact with the second alignment film 542.

In some embodiments, the third substrate 51 further includes a first water-oxygen isolation film 513 disposed on an outer side or an inner side of the first flexible substrate 510, the fourth substrate 54 further includes a second water-oxygen isolation film 543 disposed on an outer side or an inner side of the second flexible substrate 540. Each of the first water-oxygen isolation film 513 and the second water-oxygen isolation film 543 is mainly made of a mixture of silicon nitride and silicon oxide, and mainly functions to protect the dimming assembly 5 from long-term moisture permeation.

In some embodiments, each of the first flexible substrate 510 and the second flexible substrate 540 is made of any one of PET (polyethylene terephthalate, of which the chemical formula is (C10H₈O₄)ₙ), PC (linear polyester carbonate), TAC (triacetyl cellulose), or COP (cyclic olefin polymer). Each of the first electrode layer 511 and the second electrode layer 541 is made of indium tin oxide. A thickness of a layer formed by indium tin oxide can be ultra-thin, which is beneficial to realization of the flexibility of the third substrate 51 and the fourth substrate 54. Indium tin oxide is transparent, thereby achieving the light-transmitting property of the third substrate 51 and the fourth substrate 54. Each of the first alignment film 512 and the second alignment film 542 is made of a material of polyimide. The first alignment film 512 and the second alignment film 542 are formed by a coating curing process, at a curing temperature about 100° C. to 150° C.

In some embodiments, each of first flexible substrate 510 and second flexible substrate 540 has a thickness ranging from 60 μm to 188 μm, and a transmittance greater than 85%. Each of the first water-oxygen isolation film 513 and the second water-oxygen isolation film 543 has a thickness ranging from 100 nm to 200 nm. Each of the first electrode layer 511 and the second electrode layer 541 has a thickness ranging from 100 nm to 150 nm. Each of the first alignment film 512 and the second alignment film 542 has a thickness ranging from 65 nm to 100 nm. The dimming assembly 5 has a thickness ranging from 0.21 mm to 0.4 mm.

In some embodiments, the liquid crystal 50 is filled with molecules of a dye, i.e., the liquid crystal 50 is a dye liquid crystal. In a normal application of the dimming device, the dye liquid crystal cannot allow light to pass therethrough and at this time the dimming device is in an opaque state if no voltage is applied across the first electrode layer 511 and the second electrode layer 541, and the dye liquid crystal allows light to pass therethrough and at this time the dimming device is in a transparent state if a voltage is applied across the first electrode layer 511 and the second electrode layer 541.

In some embodiments, the first sealant 52 may be a light-shielding adhesive or a light-transmitting adhesive, and may have a width of 4 mm 7 mm. Further, the first sealant 52 contains therein circular silicon balls, and each of the circular silicon balls has a diameter about 8.3 μm to 12.3 μm, and a height greater than a height of each spacer 53 by 0.3 μm.

In some embodiments, referring to FIG. 1d that is a schematic top view illustrating a structure of another dimming device according to an embodiment of the present disclosure, the first electrode layer 511 further extends to the outside of the first sealant 52 and forms a first binding electrode, the second electrode layer 541 further extends to the outside of the first sealant 52 and forms a second binding electrode. The first binding electrode and the second binding electrode are both located on a same side of the dimming assembly 5, and orthogonal projections of the first binding electrode and the second binding electrode on the first flexible substrate 510 do not overlap with each other. The dimming device further includes a first flexible circuit board 8 and a second flexible circuit board 9. The first binding electrode is bound and connected with the first flexible circuit board 8, and the second binding electrode is bound and connected with the second flexible circuit board 9. The first flexible circuit board 8 and the second flexible circuit board 9 are connected to a peripheral driving circuit, such that the driving circuit can supply a driving signal to the first electrode layer 511 and the second electrode layer 541.

In some embodiments, the first electrode layer 511 and the second electrode layer 541 are planar electrodes, respectively.

In some embodiments, each of the first flexible circuit board 8 and the second flexible circuit board 9 extends 4 cm to 20 cm in length. The first flexible circuit board 8 and the second flexible circuit board 9 extend in a same direction.

In some embodiments, each of the first substrate 1 and the second substrate 2 is a toughened glass plate, and has a thickness ranging from 1.6 mm to 2.1 mm. Each of the first substrate 1 and the second substrate 2 has a curvature of 12 mm/m to 39 mm/m in an x direction of a planar coordinate system where each of the first substrate 1 and the second substrate 2 is located, and has a curvature of 19 mm/m to 26 mm/m in a y direction of the planar coordinate system.

In some embodiments, referring to FIGS. 1a and 1b, an orthogonal projection of a first side 500 of the dimming assembly 5 on a plane where the first substrate 1 is located does not overlap with orthogonal projections of the first adhesive layer 3 and the second adhesive layer 4 on the plane where the first substrate 1 is located, and the first sealant 52 extends from the first side 500 to form at least one opening 501. An end of each opening 501 is flush with a first side 500 of each of the third substrate 51 and the fourth substrate 54, and an end of each opening 501 is sealed by an opening-sealing adhesive 502. Each opening 501 is for filling the liquid crystal 50 into the alignment gap.

In some embodiments, the at least one opening 501 includes two openings 501 spaced apart from each other. The first flexible circuit board 8 and the second flexible circuit board 9 are disposed on the first side 500 of the dimming assembly 5, and orthogonal projections of the first flexible circuit board 8 and the second flexible circuit board 9 on the first flexible substrate 510 do not overlap with and an orthogonal projection of each opening 501 on the first flexible substrate 510.

In some embodiments, each opening 501 for liquid crystal filling has a width, which is parallel to the first side 500, in a range of 5 mm to 12 mm, and a length, which is perpendicular to the first side 500, in a range of 2 cm to 3 cm. A length of a portion of the first side 500 of the dimming assembly 5 exposed outside the first adhesive layer 3 and the second adhesive layer 4 is 1 cm. In some embodiments, the portion of the first side 500 of the dimming assembly 5 exposed outside the first adhesive layer 3 and the second adhesive layer 4 may be cut out.

In some embodiments, orthogonal projections of the first substrate 1, the first adhesive layer 3, the second adhesive layer 4 and the second substrate 2 on the plane where the first substrate 1 is located coincide with each other, and a distance between another side of the dimming assembly 5 except the first side 500 and a respective side of the first adhesive layer 3 is in a range of 5 mm to 15 mm.

In some embodiments, referring to FIG. 1c that is a partially enlarged view of openings for filling liquid crystal of the dimming assembly shown in FIG. 1a, the opening-sealing adhesive 502 is cured and seals each opening by illumination of 200 nm to 400 nm UV light for 5 s to 10 s. The opening-sealing adhesive 502 has a thermal expansion coefficient of 5.7×10⁻⁵/° C., a hardness of 70 to 120, and an elongation-contraction rate of 0 to 20%. A height h of a part of the opening-sealing adhesive 502 which overflows each opening 501 after being coated is 1 mm to 2 mm, and a width m of the part of the opening-sealing adhesive 502 which overflows each opening 501 after being coated is 1 cm to 1.5 cm.

In some embodiments, referring to FIGS. 1a and 1b, both the first adhesive layer 3 and the second adhesive layer 4 are the solid adhesives. The first adhesive layer 3 and the second adhesive layer 4 also extend to and encapsulate end faces of other sides, except the first side 500, of the dimming assembly 5.

In some embodiments, referring to FIGS. 1a and 1b, the orthogonal projections of the first substrate 1, the second substrate 2, the first adhesive layer 3 and the second adhesive layer 4 on the plane where the first substrate 1 is located coincide with each other.

In some embodiments, referring to FIGS. 1a and 1b, each of the first adhesive layer 3 and the second adhesive layer 4 is the solid adhesive, such as PVB or EVA adhesive.

In some embodiments, referring to FIG. 5a that is a schematic top view illustrating a structure of another dimming device according to an embodiment of the present disclosure, FIG. 5b is a schematic cross-sectional view illustrating a structure of the dimming device shown in FIG. 5a taken along a section line BB. The first sealant 52 surrounds to form a closed ring shape, and the first adhesive layer 3 and the second adhesive layer 4 extend to and encapsulate the end faces of the four sides of the dimming assembly 5. Four sides of the orthogonal projection of each of the first adhesive layer 3 and the second adhesive layer 4 on the first substrate 1 surround outside the periphery of the orthogonal projection of the first sealant 52 on the first substrate 1.

In some embodiments, referring to FIGS. 5a and 5b, each of the first adhesive layer 3 and the second adhesive layer 4 is the solid adhesive, such as PVB or EVA adhesive. No opening for filling liquid crystal is formed in the dimming assembly 5, i.e., in this embodiment, the liquid crystal 50 of the dimming assembly 5 is dropped onto an opposite surface of one of the third substrate 51 and the fourth substrate 54 before the third substrate 51 and the fourth substrate 54 are aligned and assembled, and then is sealed by the first sealant 52 after the third substrate 51 and the fourth substrate 54 are aligned and assembled. Since the plurality of columnar spacers 53 are formed between the third substrate 51 and the fourth substrate 54, the columnar spacers 53 can provide good and uniform support for the third substrate 51 and the fourth substrate 54 when the first substrate 1, the first adhesive layer 3, the dimming assembly 5 into which the liquid crystal has been filled, the second adhesive layer 4 and the second substrate 2 are stacked together, and can eliminate or avoid the Mura phenomenon caused by an uneven pressure applied to the liquid crystal 50 during the stacking process.

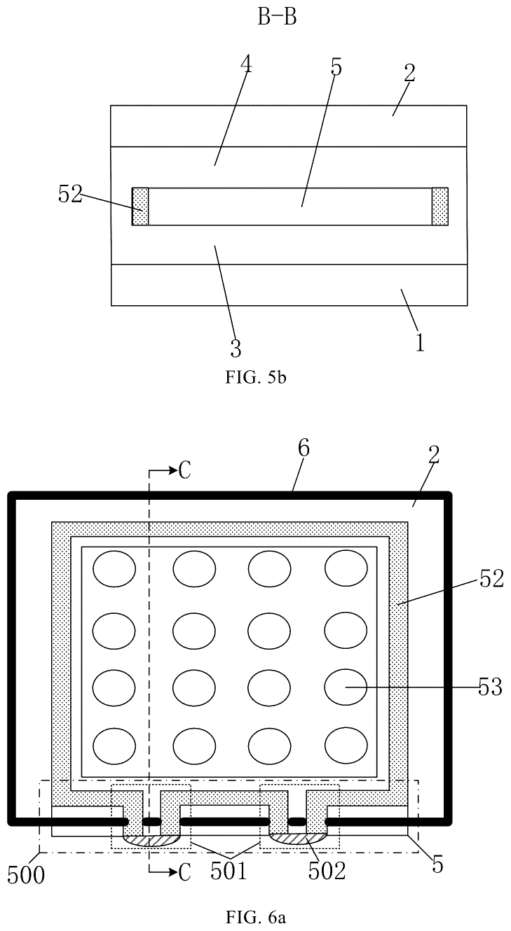

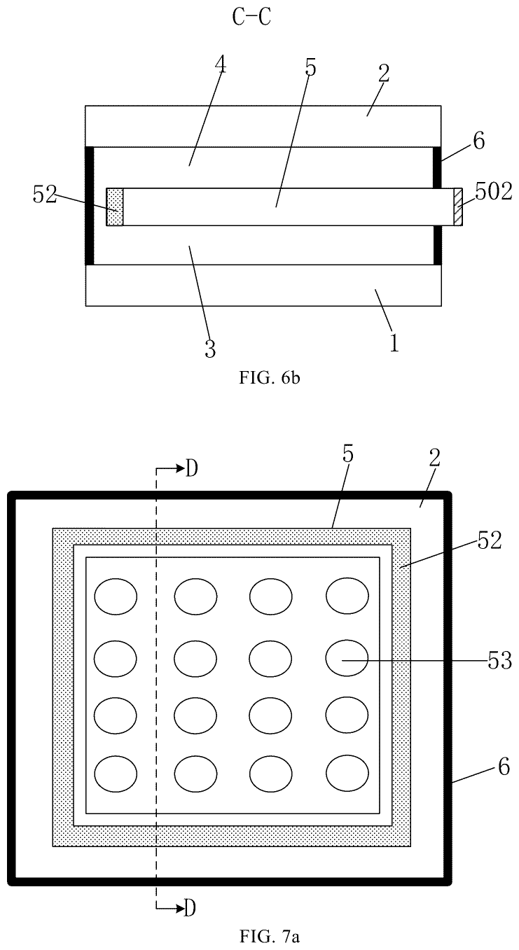

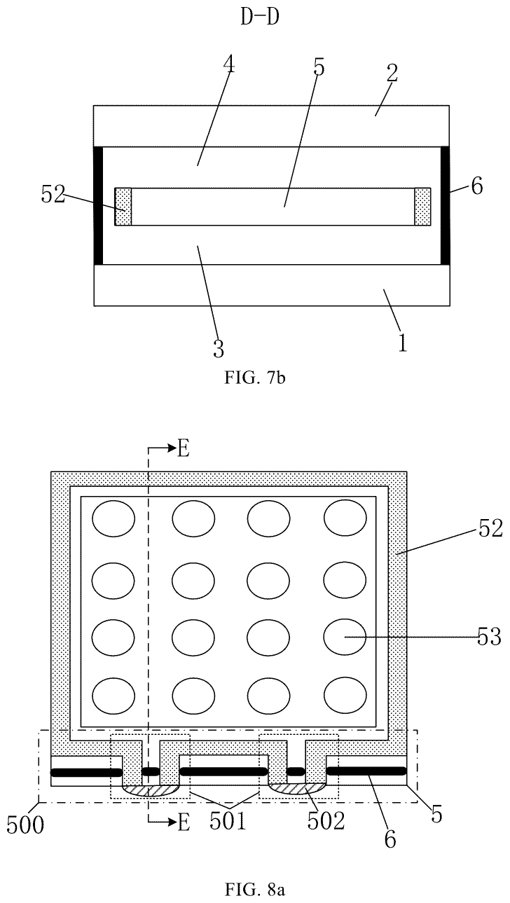

In some embodiments referring to FIGS. 6a and 6b and FIGS. 7a and 7b, FIG. 6a is a schematic top view illustrating a structure of another dimming device according to an embodiment of the present disclosure, FIG. 6b is a schematic cross-sectional view illustrating a structure of the dimming device shown in FIG. 6a taken along a section line CC, FIG. 7a is a schematic top view illustrating a structure of another dimming device according to an embodiment of the present disclosure, and FIG. 7b is a schematic cross-sectional view illustrating a structure of the dimming device shown in FIG. 7a taken along a section line DD. One of the first adhesive layer 3 and the second adhesive layer 4 is the solid adhesive, and the other thereof is made of the liquid adhesive. The orthogonal projections of the first substrate 1 and the second substrate 2 on the plane where the first substrate 1 is located coincide with each other, and the orthogonal projections of the first adhesive layer 3 and the second adhesive layer 4 on the plane where the first substrate 1 is located coincide with each other. Fourth sides of the orthogonal projection of each of the first substrate 1 and the second substrate 2 on the plane where the first substrate 1 is located surround outside respective sides of the orthogonal projection of each of the first adhesive layer 3 and the second adhesive layer 4 on the plane where the first substrate 1 is located.

In some embodiments, referring to FIGS. 6a and 6b and FIGS. 7a and 7b, the dimming device further includes a second sealant 6, which is located between the first substrate 1 and the second substrate 2, surrounds the peripheral regions of the first substrate 1 and the second substrate 2, and is in contact with and connected to the first substrate 1 and the second substrate 2. An orthogonal projection of the second sealant 6 on the first substrate 1 is positioned at the periphery of the orthogonal projection of each of the first adhesive layer 3 and the second adhesive layer 4 on the first substrate 1.

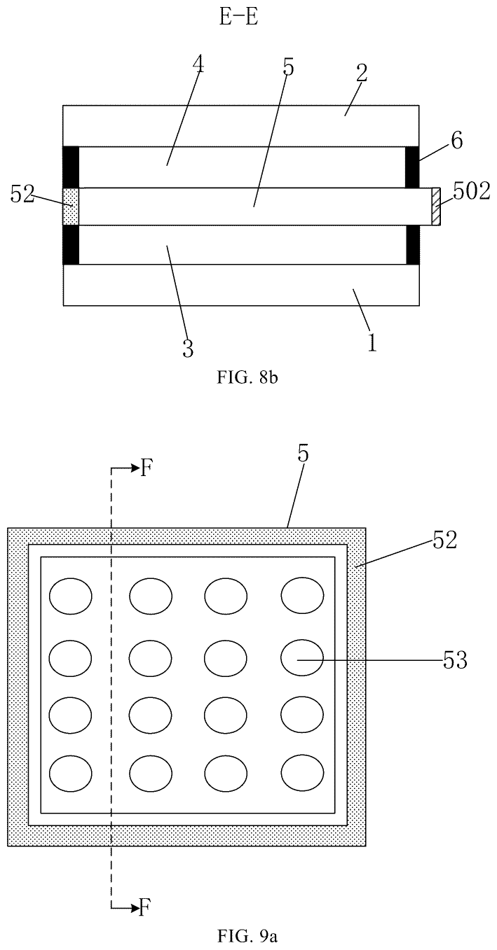

In some embodiments referring to FIGS. 8a and 8b, FIG. 8a is a schematic top view illustrating a structure of another dimming device according to an embodiment of the present disclosure, and FIG. 8b is a schematic cross-sectional view illustrating a structure of the dimming device shown in FIG. 8a taken along a section line EE. Each of the first adhesive layer 3 and the second adhesive layer 4 is made of the liquid adhesive. Orthogonal projections of other sides except the first side 500 of the first substrate 1, the dimming assembly 5 and the second substrate 2 on the plane where the first substrate 1 is located overlap with each other. Orthogonal projections of other sides except the first side 500 of the dimming assembly 5 on the plane where the first substrate 1 is located do not overlap with the orthogonal projections of the first adhesive layer 3 and the second adhesive layer 4 on the plane where the first substrate 1 is located. The orthogonal projections of the first substrate 1 and the second substrate 2 on the plane where the first substrate 1 is located coincide with each other. The orthogonal projections of the first adhesive layer 3 and the second adhesive layer 4 on the plane where the first substrate 1 is located coincide with each other. The periphery (e.g. four sides) of the orthogonal projection of each of the first substrate 1 and the second substrate 2 on the plane where the first substrate 1 is located surround(s) outside the periphery of the orthogonal projection of each of the first adhesive layer 3 and the second adhesive layer 4 on the plane where the first substrate 1 is located.

In some embodiments, referring to FIGS. 8a and 8b, the dimming device further includes a second sealant 6, which is located between the first substrate 1 and the dimming assembly 5, surrounds the peripheral regions of the first substrate 1 and the dimming assembly 5, and is in contact with and connected to the first substrate 1 and the dimming assembly 5. Further, the second sealant 6 is positioned between the second substrate 2 and the dimming assembly 5, surrounds the peripheral regions of the second substrate 2 and the dimming assembly 5, and is in contact with and connected to the second substrate 2 and the dimming assembly 5. An orthogonal projection of the second sealant 6 on the first substrate 1 is positioned at the periphery of the orthogonal projection of each of the first adhesive layer 3 and the second adhesive layer 4 on the first substrate 1.

In some embodiments, referring to FIG. 8a, orthogonal projections of portions of the first sealant 52 and the second sealant 6 on the other sides of the dimming assembly 5 except the first side 500 on the first substrate 1 overlap with each other.

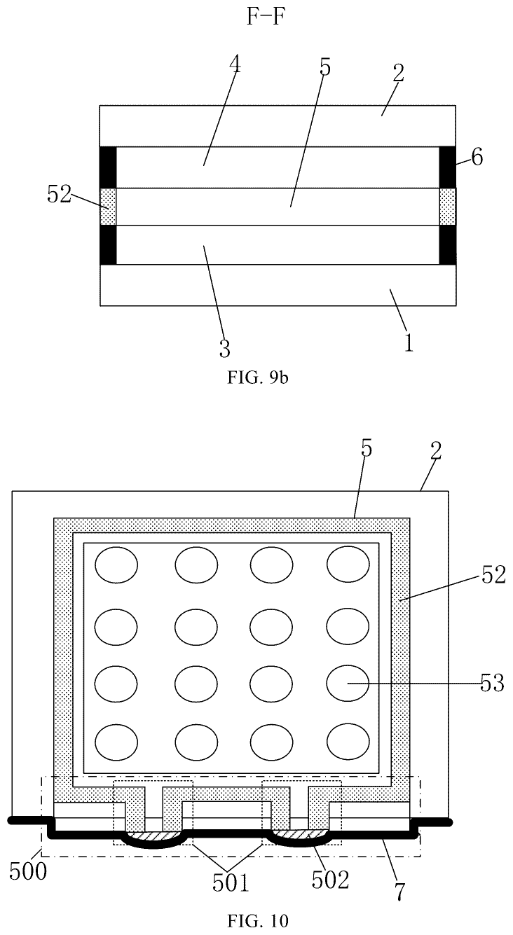

In some embodiments referring to FIGS. 9a and 9b, FIG. 9a is a schematic top view illustrating a structure of another dimming device according to an embodiment of the present disclosure, and FIG. 9b is a schematic cross-sectional view illustrating a structure of the dimming device shown in FIG. 9a taken along a section line FF. Each of the first adhesive layer 3 and the second adhesive layer 4 is made of the liquid adhesive. The first sealant 52 surrounds to form a closed ring shape. Orthogonal projections of the periphery (e.g., four sides) of the first substrate 1, the periphery (e.g., four sides) of the dimming assembly 5 and the periphery (e.g., four sides) of the second substrate 2 on the plane where the first substrate 1 is located overlap with each other. The orthogonal projections of the periphery (e.g., four sides) of the dimming assembly 5 on the plane where the first substrate 1 is located do not overlap with the orthogonal projections of the first adhesive layer 3 and the second adhesive layer 4 on the plane where the first substrate 1 is located. The orthogonal projections of the first substrate 1 and the second substrate 2 on the plane where the first substrate 1 is located coincide with each other. The orthogonal projections of the first adhesive layer 3 and the second adhesive layer 4 on the plane where the first substrate 1 is located coincide with each other. The periphery (e.g., four sides) of the orthogonal projection of each of the first substrate 1 and the second substrate 2 on the plane where the first substrate 1 is located surround(s) the periphery of the orthogonal projection of each of the first adhesive layer 3 and the second adhesive layer 4 on the plane where the first substrate 1 is located.

In some embodiments, referring to FIGS. 9a and 9b, the dimming device further includes a second sealant 6, which is located between the first substrate 1 and the dimming assembly 5, surrounds the peripheral regions of the first substrate 1 and the dimming assembly 5, and is in contact with and connected to the first substrate 1 and the dimming assembly 5. Further, the second sealant 6 is located between the second substrate 2 and the dimming assembly 5, surrounds the peripheral regions of the second substrate 2 and the dimming assembly 5, and is in contact with and connected to the second substrate 2 and the dimming assembly 5. The orthogonal projection of the second sealant 6 on the first substrate 1 is positioned at the periphery of each of the orthogonal projections of the first adhesive layer 3 and the second adhesive layer 4 on the first substrate 1.

In some embodiments, referring to FIGS. 9a and 9b, the orthogonal projections of the first sealant 52 and the second sealant 6 on the first substrate 1 overlap with each other.

In some embodiments, a width of the second sealant 6 ranges from 2 mm to 6 mm.

In some embodiments, the second sealant 6 is an adhesive of type DM608 sealant. The second sealant 6 is cured under conditions: a temperature of 25° C.±2° C. and an ambient humidity (RH)>60%±10%. After being cured, the second sealant 6 becomes a black paste with a Shore hardness of 35±7A and a bonding strength≥0.8 Mpa. The second sealant 6 is black and opaque (i.e., light-proof), has a Tg (temperature for converting from a glass state to a viscous state) of −40.1° C., and has no UV light cut-off function.

In some embodiments, referring to FIG. 10 that is a schematic top view illustrating a structure of another dimming device according to an embodiment of the present disclosure, the dimming device further includes an edge-sealing adhesive 7, which is located on the first side 500 of the dimming assembly 5, and on a side of the opening-sealing adhesive 502 distal to the openings 501. The edge-sealing adhesive 7 extends to cover the first side 500. The edge-sealing adhesive 7 can prevent the opening-sealing adhesive 502 of the openings 501 for filling liquid crystal from water vapor intolerance, and prevent water vapor from entering the alignment gap of the dimming assembly 5.

In some embodiments, a width of the edge-sealing adhesive 7 is in a range of 1 cm to 2 cm, and is a thickness of the edge-sealing adhesive 7 in a direction away from the opening-sealing adhesive 502.

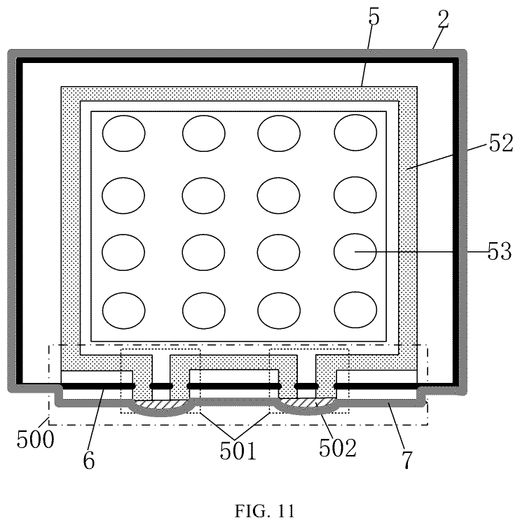

In some embodiments, referring to FIG. 11 that is a schematic top view illustrating a structure of another dimming device according to an embodiment of the present disclosure, each of the first adhesive layer 3 and the second adhesive layer 4 of the dimming device is made of the liquid adhesive, and in this case, the edge-sealing adhesive 7 may encapsulate the periphery of the second sealant 6 of the dimming device, so as to effectively prevent the moisture from permeating into the dimming device and avoid the intrusion of water vapor during the reliability high-temperature boiling.

In some embodiments, the dimming device further includes a border blocking layer at least located on a side of one of the first substrate 1 and the second substrate 2 distal to the dimming assembly 5, and an orthogonal projection of the border blocking layer on the plane where the first substrate 1 is located covers a region outside the effective dimming region surrounded by the first sealant 52.

In some embodiments, a border portion on any side of the dimming device blocked by the border blocking layer has a width ranging from 8 mm to 23 mm. In some embodiments, the border blocking layer is made of a black light-blocking material, such as ink.

The embodiments of the present disclosure further provide a method for manufacturing the dimming device, and the method includes step S100 of forming the dimming assembly of which the alignment gap is not filled with liquid crystal.

In a case where the first adhesive layer and the second adhesive layer are both the solid adhesives, the method for manufacturing the dimming device includes the following steps S101 to S103. Step S101 includes sequentially stacking the first substrate, the first adhesive layer, the dimming assembly of which the alignment gap is not filled with liquid crystal, the second adhesive layer and the second substrate, and assembling them together in a high-pressure kettle.

Step S102 includes filling liquid crystal into the alignment gap through an opening for filling liquid crystal in a vacuum chamber at the normal temperature (i.e., room temperature).

Step S103 includes sealing the opening for filling liquid crystal by using the opening-sealing adhesive.

In a case where the first adhesive layer is the solid adhesive and the second adhesive layer is made of the liquid adhesive, the method for manufacturing the dimming device includes the following steps S201 to S204. Step S201 includes sequentially stacking the first substrate, the first adhesive layer and the dimming assembly of which the alignment gap is not filled with liquid crystal, and assembling them together in the high-pressure kettle.

Step S202 includes filling liquid crystal into the alignment gap through an opening for filling liquid crystal in the vacuum chamber at the normal temperature.

Step S203 includes sealing the opening for filling liquid crystal by using the opening-sealing adhesive to form a semi-finished product.

Step S204 includes attaching the semi-finished product to the second substrate to form a cavity therebetween, reserving an injection opening in an adhesive for the attaching, injecting a material of the second adhesive layer into the cavity, and curing the material.

In a case where each of the first adhesive layer and the second adhesive layer is made of the liquid adhesive, the method for manufacturing the dimming device includes the following steps S301 to S304. Step S301 includes attaching the first substrate and the dimming assembly of which the alignment gap is not filled with liquid crystal to form a cavity, reserving an injection opening in an adhesive for the attaching, injecting a material of the first adhesive layer into the cavity, and curing the material of the first adhesive layer to form a semi-finished product.

Step S302 includes attaching the semi-finished product to the second substrate to form a cavity, reserving an injection opening in an adhesive for the attaching, injecting a material of the second adhesive layer into the cavity, and curing the material of the second adhesive layer.

Step S303 includes filling liquid crystal into the alignment gap through an opening for filling liquid crystal in the vacuum chamber at the normal temperature.

Step S304 includes sealing the opening for filling liquid crystal by using the opening-sealing adhesive.

In the method for manufacturing the dimming device according to the present embodiment, the dimming assembly of the dimming device is provided with the opening for filling liquid crystal.

In some embodiments, the dimming device shown in FIG. 1a is manufactured by the method for manufacturing the dimming device including step S100, i.e., including step S101 to step S103. The exemplary method for manufacturing the dimming device shown in FIG. 1a is as follows: sequentially stacking the first substrate, the first adhesive layer, the dimming assembly of which the alignment gap is not filled with liquid crystal, the second adhesive layer and the second substrate in this sequence; placing the stacked structure into the high-pressure kettle to be assembled at 120° C. to 145° C. under the pressure of 1 bar to 12 bar to form a hollow assembly; putting the hollow assembly into a vacuum liquid crystal filling device (such as a vacuum liquid crystal groove) to fill liquid crystal; and sealing the opening for filling liquid crystal to form the dimming device. In some embodiments, the method for manufacturing the dimming device may further include: coating the edge-sealing adhesive on the side of the opening-sealing adhesive distal to the opening for filling liquid crystal, such that the edge-sealing adhesive encapsulate at least a side (i.e., the first side), on which the opening for filling liquid crystal is located, of the dimming device, thereby preventing water vapor from entering into the dimming assembly through the opening-sealing adhesive.

In some embodiments, the dimming device shown in FIG. 6a is manufactured by the method for manufacturing the dimming device including step S100, i.e., including step S201 to step S204. The exemplary method for manufacturing the dimming device shown in FIG. 6a is as follows: sequentially stacking the first substrate, the first adhesive layer and the dimming assembly of which the alignment gap is not filled with liquid crystal; placing the stacked structure into the high-pressure kettle to be assembled at 120° C. to 145° C. under the pressure of 1 bar to 12 bar to form a hollow assembly; putting the hollow assembly into a vacuum liquid crystal filling device (such as a vacuum liquid crystal groove) to fill liquid crystal; sealing the opening for filling liquid crystal to form a semi-finished dimming device; attaching the peripheral regions of the second substrate and the semi-finished dimming device to each other by using the second sealant, to form a cavity and reserve an injection opening in the second sealant, injecting the OCR (such as US108) in a liquid state into the cavity through a needle and the reserved injection opening; curing the OCR at 60° C. for 30 min, statically leveling the OCR for 10 min, defoaming the OCR at 40° C. to 60° C. for 30 min to 50 min; and finally, sealing the reserved injection opening to form the dimming device.

In some embodiments, the dimming device shown in FIG. 8a is manufactured by the method for manufacturing the dimming device including step S100, i.e., including step S301 to step S304. The exemplary method for manufacturing the dimming device shown in FIG. 8a is as follows: attaching the peripheral regions of the first substrate and the dimming assembly of which the alignment gap is not filled with liquid crystal to each other by using the second sealant, to form a cavity and reserve an injection opening in the second sealant; filling the OCR (such as US108) in the liquid state into the cavity through a needle and the reserved injection opening; curing the OCR at 60° C. for 30 min, statically leveling the OCR for 10 min, defoaming the OCR at 40° C. to 60° C. for 30 min to 50 min; sealing the reserved injection opening to form a semi-finished product; attaching the dimming assembly of which the alignment gap is not filled with liquid crystal in the semi-finished product to the second substrate by using the second sealant, to form a cavity and reserve an injection opening in the second sealant; filling the OCR (such as US108) in the liquid state into the cavity through a needle and the reserved injection opening; curing the OCR at 60° C. for 30 min, statically leveling the OCR for 10 min, defoaming the OCR at 40° C. to 60° C. for 30 min to 50 min; sealing the reserved injection opening to form a hollow assembly with double-sided OCR; putting the hollow assembly into a vacuum liquid crystal filling device (such as a vacuum liquid crystal groove) to fill liquid crystal; and sealing the opening for filling liquid crystal to form the dimming device.

In some embodiments, the sealing the opening for filling liquid crystal includes: coating a 3052-opening-sealing adhesive on the opening for filling liquid crystal, and curing the opening-sealing adhesive by irradiation of 200 nm to 400 nm UV light for 5 s to 10 s.

In some embodiments, step S100 of forming the dimming assembly of which the alignment gap is not filled with liquid crystal includes: forming the first electrode layer on the first flexible substrate by using a patterning process (which includes film forming, exposing, developing, etching, and/or the like), forming the second electrode layer on the second flexible substrate; forming the plurality of columnar spacers on the first electrode layer by using a patterning process (which includes film forming, exposing, developing, and/or the like) or a screen printing process; coating an alignment film material (such as polyimide) on the opposite surfaces of the first flexible substrate and the second flexible substrate which have been subjected to the above steps, performing thermosetting on the alignment film material at 90° C. to 150° C., and performing friction alignment or illumination alignment on the alignment films to form the first alignment film and the second alignment film, thereby completing the formation of the third substrate and the fourth substrate; coating the first sealant on the peripheral region of the third substrate or the fourth substrate, aligning and assembling the third substrate and the fourth substrate, and performing thermosetting on the first sealant at 100° C. to 150° C., to form the dimming assembly and the opening(s) for filling liquid crystal.

In some embodiments, the forming the spacers may include: coating a photoresist film (such as a negative photoresist film) on a side of the first electrode layer distal to the first flexible substrate; drying the photoresist film at 90° C. for 120 seconds, so as to remove a micromolecule solvent from the photoresist film and reduce the fluidity of the photoresist; and

exposing the photoresist film with ultraviolet light (i.e., UV light, which is generally a wave band of 300 nm to 436 nm) by using a mask having a light-transmitting pattern, to allow a portion of the photoresist film in a region corresponding to the light-transmitting pattern to undergo polymerization reaction; spraying a potassium hydroxide (KOH) solution on the exposed photoresist film, to remove a portion of the photoresist film which does not undergo polymerization reaction in a region except the light-transmitting pattern to form a pattern of the spacers (for example, spraying a 0.04 wt % potassium hydroxide solution on the exposed photoresist film, to clean out the portion of the photoresist film which does not undergo polymerization reaction); and curing the pattern of the spacers at 110° C. for 50 minutes to 60 minutes to form the spacers.

The embodiments of the present disclosure further provide another method for manufacturing the dimming device, and the method includes step S100′ of forming the dimming assembly of which the alignment gap is filled with liquid crystal.

In this step, the same patterning process or screen printing process as that in the foregoing embodiments is adopted to form the columnar spacers of the dimming assembly. The third substrate and the fourth substrate of the dimming assembly are formed in the same way as in the foregoing embodiments. After the third substrate and the fourth substrate are formed, liquid crystal is dropped on an opposite surface of the third substrate or the fourth substrate, then the first sealant is coated on the peripheral region of the third substrate or the fourth substrate, and the third substrate and the fourth substrate are aligned and assembled, to form the dimming assembly of which the alignment gap is filled with liquid crystal. In this case, the dimming assembly does not need to be provided with an opening for filling liquid crystal.

In a case where the first adhesive layer and the second adhesive layer are both the solid adhesives, the method for manufacturing the dimming device includes step S101′ of sequentially stacking the first substrate, the first adhesive layer, the dimming assembly, the second adhesive layer and the second substrate, and assembling them together in the high-pressure kettle.

In a case where the first adhesive layer is the solid adhesive and the second adhesive layer is made of the liquid adhesive, the method for manufacturing the dimming device includes the following steps S201′ to S202′. Step S201′ includes sequentially stacking the first substrate, the first adhesive layer and the dimming assembly, and assembling them together in the high-pressure kettle, to form a semi-finished product.

Step S202′ includes attaching the semi-finished product to the second substrate to form a cavity, reserving an injection opening in an adhesive for the attaching, injecting a material of the second adhesive layer into the cavity, and curing the material of the second adhesive layer.

In a case where the first adhesive layer and the second adhesive layer are both made of the liquid adhesives, the method for manufacturing the dimming device includes the following steps S301′ to S302′. Step S301′ includes attaching the first substrate to the dimming assembly to form a cavity, reserving an injection opening in an adhesive for the attaching, injecting a material of the first adhesive layer into the cavity, and curing the material of the first adhesive layer, to form a semi-finished product.

Step S302′ includes attaching the semi-finished product to the second substrate to form a cavity, reserving an injection opening in an adhesive for the attaching, injecting a material of the second adhesive layer into the cavity, and curing the material of the second adhesive layer.

In the methods for manufacturing the dimming device in these embodiments, the dimming assembly of the dimming device is not provided with an opening for filling liquid crystal.

In some embodiments, the dimming device shown in FIG. 5a is manufactured by using the manufacturing method including steps S100′ to S101′. The exemplary method for manufacturing the dimming device shown in FIG. 5a is as follows: sequentially stacking the first substrate, the first adhesive layer, the dimming assembly, the second adhesive layer and the second substrate in this sequence; placing the stacked structure into a bag and vacuuming the bag, laminating the stacked structure at 90° C., placing the stacked structure into the high-pressure kettle, and laminating the stacked structure at a temperature of 110° C. to 145° C. under a pressure of 1 bar to 12 bar for 1 hour, to form the dimming device.

In some embodiments, the method for manufacturing the dimming device shown in FIG. 5a may further include: coating the edge-sealing adhesive on the end faces at periphery of the dimming device to allow the edge-sealing adhesive to further encapsulate the end faces at the periphery of the dimming device, thereby preventing water vapor from entering the dimming device.

In some embodiments, the dimming device shown in FIG. 7a is manufactured by using the manufacturing method including steps S100′ and S201′ to S202′. The exemplary method for manufacturing the dimming device shown in FIG. 7a is as follows: sequentially stacking the first substrate, the first adhesive layer and the dimming assembly, bagging and vacuuming the stacked structure, laminating the stacked structure at 90° C., placing the stacked structure into the high-pressure kettle, laminating the stacked structure at a temperature of 110° C. to 145° C. under a pressure of 1 bar to 12 bar for 1 hour, to form a semi-finished dimming device; attaching the peripheral regions of the semi-finished dimming device and the second substrate to each other by using the second sealant, to form a cavity and reserve an injection opening in the second sealant, and then injecting the OCR (such as US108) in the liquid state into the cavity through a needle and the reserved injection opening; curing the OCR at 60° C. for 30 min, statically leveling the OCR for 10 min, defoaming the OCR at 40° C. to 60° C. for 30 min to 50 min; and finally, sealing the reserved injection opening to form the dimming device.

In some embodiments, the dimming device shown in FIG. 9a is manufactured by using the manufacturing method including steps S100′ and S301′ to S302′. The exemplary method for manufacturing the dimming device shown in FIG. 9a is as follows: attaching the peripheral regions of the first substrate and the dimming assembly to each other by using the second sealant, to form a cavity and reserve an injection opening in the second sealant; injecting the OCR (such as US108) in the liquid state into the cavity through a needle and the reserved injection opening; curing the OCR at 60° C. for 30 min, statically leveling the OCR for 10 min, defoaming the OCR at 40° C. to 60° C. for 30 min to 50 min; and then sealing the reserved injection opening to form a semi-finished product; attaching the dimming assembly of the semi-finished product to the second substrate by using the second sealant, to form a cavity and reserve an injection opening in the second sealant; filling the OCR (such as US108) in the liquid state into the cavity through a needle and the reserved injection opening; curing the OCR at 60° C. for 30 min, statically leveling the OCR for 10 min, defoaming the OCR at 40° C. to 60° C. for 30 min to 50 min; and finally sealing the reserved injection opening to form the dimming assembly with double-sided OCR.

In the dimming devices provided by the embodiments of the present disclosure, in the case where the first adhesive layer and the second adhesive layer are both the solid adhesives, liquid crystal can be filled into the dimming assembly after the first substrate, the first adhesive layer, the dimming assembly not filled with liquid crystal, the second adhesive layer and the second substrate are laminated, thereby avoiding the Mura phenomenon caused by uneven pressure applied on the liquid crystal in the lamination process. In the case where one of the first adhesive layer and the second adhesive layer adopts the liquid adhesive, the liquid adhesive can be filled to realize the solidification and bonding of the one of the first adhesive layer and the second adhesive layer after the upper and lower layers to be bonded to the one of the first adhesive layer and the second adhesive layer are laminated to each other. Alternatively, in the case where the first adhesive layer and the second adhesive layer are both made of the liquid adhesives, after the first substrate, the dimming assembly and the second substrate are aligned and assembled together, the liquid adhesives can be filled to sequentially realize solidification and bonding of the first adhesive layer and the second adhesive layer, thereby avoiding the Mura phenomenon caused by unevenness of the thickness of the adhesive layer fluctuating beyond a micrometer level. In addition, by providing the columnar spacers in the dimming assembly, good support to the upper and lower substrates in a process of stacking layers of the dimming device together can be satisfied, and the Mura phenomenon is preventing from occurring in the dimming device.

The dimming device according to any one of the foregoing embodiments of the present disclosure can serve as a window of various vehicles, an indoor window, and/or the like.

An embodiment of the present disclosure further provides a vehicle, which includes the dimming device according to any one of the foregoing embodiments of the present disclosure, and the dimming device serve as a window of the vehicle.

By adopting the dimming device according to any one of the foregoing embodiments of the present disclosure, the vehicle has a window with an improved dimming effect, and thus has an improved quality.

It will be understood that the above embodiments are merely exemplary embodiments employed to illustrate the principles of the present disclosure, and the present disclosure is not limited thereto. It will be apparent to one of ordinary in the art that various changes and modifications can be made therein without departing from the spirit and scope of the present disclosure, and these changes and modifications are to be considered within the scope of the present disclosure.

1. A dimming device, comprising a first substrate, a second substrate, a first adhesive layer, a second adhesive layer, and a dimming assembly; wherein
the first substrate, the first adhesive layer, the dimming assembly, the second adhesive layer and the second substrate are sequentially stacked together;
the dimming assembly comprises a third substrate, a first sealant, a plurality of spacers, and a fourth substrate, the third substrate and the fourth substrate are aligned and assembled to form an alignment gap therebetween, and liquid crystal is filled in the alignment gap;
the plurality of spacers are positioned between the third substrate and the fourth substrate, and positioned in a region surrounded by the first sealant;
the first sealant is positioned between the third substrate and the fourth substrate, and surrounds peripheral regions of the third substrate and the fourth substrate, so as to bond and encapsulate the peripheral regions of the third substrate and the fourth substrate;
the first adhesive layer and the second adhesive layer at least cover an effective dimming region of the dimming assembly;
the effective dimming region is a region surrounded by the first sealant; and
each of the first adhesive layer and the second adhesive layer is a solid adhesive; or, at least one of the first adhesive layer and the second adhesive layer is made of a liquid adhesive.

2. The dimming device according to claim 1, wherein orthogonal projections of a first side of the dimming assembly, the first adhesive layer, and the second adhesive layer on a plane where the first substrate is located do not overlap with each other; and
the first sealant extends at the first side to form at least one opening, an end of each opening is flush with first sides of the third substrate and the fourth substrate, and is sealed by an opening-sealing adhesive, and the at least one opening is configured to fill the liquid crystal into the alignment gap.

3. The dimming device according to claim 2, wherein the first adhesive layer and the second adhesive layer extend to and encapsulate end faces of other sides of the dimming assembly except the first side; and
wherein orthogonal projections of the first substrate, the second substrate, the first adhesive layer and the second adhesive layer on the plane where the first substrate is located coincide with each other.

4. (canceled)

5. The dimming device according to claim 1, wherein the first sealant surrounds to form a closed ring shape;
the first adhesive layer and the second adhesive layer extend to and encapsulate an end face of a periphery of the dimming assembly; and
a periphery of an orthogonal projection of each of the first adhesive layer and the second adhesive layer on the first substrate surrounds outside a periphery of an orthogonal projection of the first sealant on the first substrate.

6. The dimming device according to claim 3, wherein orthogonal projections of the first substrate and the second substrate on a plane where the first substrate is located coincide with each other;
orthogonal projections of the first adhesive layer and the second adhesive layer on the plane where the first substrate is located coincide with each other; and
a periphery of each of the orthogonal projections of the first substrate and the second substrate on a plane where the first substrate is located surrounds outside a periphery of each of the orthogonal projections of the first adhesive layer and the second adhesive layer on the plane where the first substrate is located.

7. The dimming device according to claim 6, further comprising a second sealant, which is disposed between the first substrate and the second substrate, surrounds the peripheral regions of the first substrate and the second substrate, and is in contact with and connected to the first substrate and the second substrate; and
an orthogonal projection of the second sealant on the first substrate is positioned outside the orthogonal projections of the first adhesive layer and the second adhesive layer on the first substrate.

8. The dimming device according to claim 2, wherein orthogonal projections of other sides of the first substrate, the dimming assembly, and the second substrate except the first side on the plane where the first substrate is located overlap with each other;
orthogonal projections of the other sides of the dimming assembly except the first side, the first adhesive layer, and the second adhesive layer on the plane where the first substrate is located do not overlap with each other;
orthogonal projections of the first substrate and the second substrate on the plane where the first substrate is located coincide with each other;
the orthogonal projections of the first adhesive layer and the second adhesive layer on the plane where the first substrate is located coincide with each other; and
a periphery of each of the orthogonal projections of the first substrate and the second substrate on the plane where the first substrate is located surrounds outside a periphery of each of the orthogonal projections of the first adhesive layer and the second adhesive layer on the plane where the first substrate is located.

9. The dimming device according to claim 1, wherein the first sealant surrounds to form a closed ring shape;
orthogonal projections of peripheries of the first substrate, the dimming assembly, and the second substrate on a plane where the first substrate is located overlap with each other;
orthogonal projections of a periphery of the dimming assembly, the first adhesive layer, and the second adhesive layer on the plane where the first substrate is located do not overlap with each other;
orthogonal projections of the first substrate and the second substrate on the plane where the first substrate is located coincide with each other;
orthogonal projections of the first adhesive layer and the second adhesive layer on the plane where the first substrate is located coincide with each other; and
a periphery of each of the orthogonal projections of the first substrate and the second substrate on the plane where the first substrate is located surrounds outside a periphery of each of the orthogonal projections of the first adhesive layer and the second adhesive layer on the plane where the first substrate is located.

10. The dimming device according to claim 8, further comprising a second sealant, which is disposed between the first substrate and the dimming assembly, surrounds peripheral regions of the first substrate and the dimming assembly, and is in contact with and connected to the first substrate and the dimming assembly;
the second sealant is further positioned between the second substrate and the dimming assembly, surrounds the peripheral regions of the second substrate and the dimming assembly, and is in contact with and connected to the second substrate and the dimming assembly; and
an orthogonal projection of the second sealant on the first substrate is positioned outside each of orthogonal projections of the first adhesive layer and the second adhesive layer on the first substrate.

11. The dimming device according to claim 3, wherein the first adhesive layer and the second adhesive layer are both the solid adhesives; or, one of the first adhesive layer and the second adhesive layer is made of the liquid adhesive; and
each solid adhesive comprises polyvinyl butyral or ethylene-vinyl acetate copolymer.

12. The dimming device according to claim 8, wherein each of the first adhesive layer and the second adhesive layer is made of the liquid adhesive which achieves adhesion after being cured; and
the liquid adhesive comprises an acrylic resin optical adhesive or an organic silicon optical adhesive.

13. The dimming device according to claim 10, wherein the second sealant has a width in a range of 2 mm to 6 mm.

14. The dimming device according to claim 2, further comprising an edge-sealing adhesive, which is located on the first side of the dimming assembly, and on a side of the opening-sealing adhesive distal to the at least one opening; and
the edge-sealing adhesive extends to cover the first side.

15. The dimming device according to claim 14, wherein the edge-sealing adhesive has a width in a range of 1 cm to 2 cm.

16. The dimming device according to claim 1, wherein the third substrate comprises a first flexible substrate, a first electrode layer, and a first alignment film;
the first electrode layer and the first alignment film are sequentially stacked on the first flexible substrate;
the fourth substrate comprises a second flexible substrate, a second electrode layer, and a second alignment film;
the second electrode layer and the second alignment film are sequentially stacked on the second flexible substrate;
the plurality of spacers are uniformly distributed on the first electrode layer; and
a top end of at least a part of the spacers is in contact with the second alignment film.

17. The dimming device according to claim 16, wherein the first electrode layer further extends beyond the first sealant and forms a first binding electrode;
the second electrode layer further extends beyond the first sealant and forms a second binding electrode;
the first binding electrode and the second binding electrode are positioned on a same side of the dimming assembly, and orthogonal projections of the first binding electrode and the second binding electrode on the first flexible substrate do not overlap with each other;
the dimming device further comprises a first flexible circuit board and a second flexible circuit board;
the first binding electrode is bound and connected to the first flexible circuit board; and
the second binding electrode is bound and connected to the second flexible circuit board.

18. The dimming device according to claim 16, wherein a shape of each of the spacers comprises any one of a cylinder, a frustum of a cone, or a frustum of a pyramid.

19. The dimming device according to claim 18, wherein each spacer having the shape of a frustum of a cone has a bottom surface of which a diameter is in a range of 25 μm to 30 μm, a top surface of which a diameter is in a range of 15 μm to 20 μm, and a height in a range of 8 μm to 12 μm.

20. The dimming device according to claim 16, wherein a distance between any adjacent two of the spacers is in a range of 70 μm to 170 μm; and
a distance between the spacer closest to the first sealant and the first sealant is in a range of 100 μm to 1,000 μm.

21. A vehicle, comprising the dimming device according to claim 1, wherein the dimming device serves as a window of the vehicle.

22-24. (canceled)
